(19) United States
(12) Patent Application Publication
(10) Pub. No.: US 2009/0099785 A1
(43) Pub. Date: Apr. 16, 2009

(54) INFORMATION PROCESSING APPARATUS, INFORMATION PROCESSING METHOD, AND STORAGE MEDIUM

(76) Inventors: Takuro YAMAMOTO, Kanagawa (JP); Noriyuki KISHII, Kanagawa (JP); Tomohiro HAYAKAWA, Saitama (JP); Haruhiko SOMA, Tokyo (JP); Kazuhiro NAKAGAWA, Saitama (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/240,333

(22) Filed: Sep. 29, 2008

(30) Foreign Application Priority Data
Oct. 11, 2007 (JP) P2007-265106

(51) Int. Cl. G06F 19/00

(52) U.S. Cl. 702/19

(57) ABSTRACT

An information processing apparatus includes a management section configured to manage biological rhythm information about a user, and a display control section configured to display the biological rhythm information so as to be associated with an object corresponding to the user.

### CROSS REFERENCES TO RELATED APPLICATIONS

The present invention contains subject matter related to Japanese Patent Application JP 2007-265106, filed in the Japan Patent Office on Oct. 11, 2007, the entire contents of which being incorporated herein by reference.

### BACKGROUND OF THE INVENTION

1. Field of the Invention

The present invention relates to an information processing apparatus, an information processing method, and a storage medium. In particular, the present invention relates to an information processing apparatus and so on used for displaying biological rhythm information about a user so as to be associated with an avatar in a virtual space.

2. Description of the Related Art

In recent years, a service has become widespread that allows a plurality of users to share a three-dimensional virtual space (hereinafter referred to simply as a “virtual space”) when the users connect their computers to a server via the Internet. In such a service, each user is able to move his or her surrogate (i.e., an object representing the user) called an avatar (the incarnation of a Hindu deity that appears in the Hindu mythology) in the virtual space, and communicate (e.g., chat) with another user (avatar) encountered in the virtual space.

Such communication/chat using the avatars in the virtual space has been increasingly used in various applications. For example, an attempt is being made to apply such communication/chat in educational fields, for example, for interaction between students of schools that are remote from each other. Japanese Patent Laid-Open No. 2007-188310 discloses a technique, in relation to the chat in the virtual space, for facilitating search in the virtual space for an avatar of a user who has sent a chat message.

### SUMMARY OF THE INVENTION

Multiple avatars differing in appearance are commonly prepared as avatars that can be set for users in the virtual space. Examples of such avatars include those that look like animals and those that look like humans. Each user is allowed to select one of those prepared avatars as he or she desires.

In addition, it is possible to set attributes corresponding to the user for his or her avatar. For example, it is possible to assign information concerning the age, sex, country, interests, and so on of the user to his or her avatar, and make such information recognizable by other users in the virtual space. These attributes may be represented by the appearance of the avatar, e.g., an appearance of being a child, an appearance of being an adult, an appearance of being a male, or an appearance of being a female. Alternatively, when an avatar of one user attempts to start communication, such as a chat, with an avatar of another user, attributes of the two users may be displayed as character information concerning their avatars.

The attributes set in the avatars contribute to making the communication between the users in the virtual space smoother, and allowing the users to conduct activities in the virtual space more efficiently.

Today, it is known that a variety of biological phenomena of individual living beings exhibit autonomous, rhythmic cyclical variation (oscillation), and that each person leads his or her daily life with his or her own rhythm (biological rhythm). In particular, a circadian rhythm, which is an approximate daily periodicity, is considered to affect a wide variety of matters including the sleep-wake cycle, diurnal variations of the body temperature, the blood pressure, and the amount of hormone secretion, physical and mental activity, and capacity for locomotion.

Considering the fact that users from all over the world, who are living in varied time zones and leading varied lives, participate in the virtual space, the setting of information concerning the biological rhythms of the users as the attributes of their avatars will allow smoother and more efficient communication therebetween. For example, that will allow each user to take account of not only an objective time in the virtual space but also subjective times of other users, which reflect their biological rhythms, when starting a communication with another user. For example, that will enable two users to start a communication therebetween when both of them are in the most active state.

Thus, the present embodiment provides a technique for enabling the users to communicate with each other more smoothly and efficiently in the virtual space, by referring to the biological rhythm information about one another.

According to one embodiment of the present invention, there is provided an information processing apparatus including: management means for managing biological rhythm information about a user; and display control means for displaying the biological rhythm information so as to be associated with an object corresponding to the user.

In this information processing apparatus, it may be so arranged that the object exists in a virtual space, and that the display control means displays the biological rhythm information and the object so as to be associated with each other while the user is present in the virtual space.

Also, the information processing apparatus may further include determination means for: acquiring and storing biological information about the user transmitted from an external device and/or an internal measurement section, or life rhythm information about the user transmitted from an external device; automatically determining a biological rhythm of the user based on the stored biological information or the stored life rhythm information; and transmitting a result of the automatic determination to the management means as the biological rhythm information.

In this case, the biological information may be one or more pieces of information selected from the group consisting of heartbeats, a pulse, and blood pressure.

Also, the information processing apparatus may further include storage means for storing a plurality of pieces of image information for the object, wherein the display control means selects and displays one or more of the plurality of pieces of image information stored in the storage means based on the biological rhythm information.

According to another embodiment of the present invention, there is provided an information processing method including the steps of: managing biological rhythm information about a user; and displaying the biological rhythm information so as to be associated with an object corresponding to the user.

According to yet another embodiment of the present invention, there is provided a storage medium having stored therein a computer-readable program for allowing a computer to perform the steps of: managing biological rhythm information about a user; and displaying the biological rhythm information so as to be associated with an object corresponding to the user.

The term “biological rhythm information” as used herein refers to information concerning autonomous, cyclically-varying rhythm (biological rhythm) of biological phenomena of each person. Typical examples of the biological rhythm include sleep-wake cycle and diurnal variations of the body temperature and the blood pressure, which in particular exhibit diurnal variations called a circadian rhythm. The biological rhythm is unique for each individual, as controlled by a group of genes called “Clock gene” and influenced by a light environment, a life rhythm, etc.

The term “biological information” refers to one or more pieces of information selected from the group consisting of the heartbeats, the pulse, and the blood pressure. The diurnal variations of a heart rate, a pulse rate, and the blood pressure are controlled by the circadian rhythm (see “Robust circadian rhythm in heart rate and its variability: influence of exogenous melatonin and photoperiod.,” Journal of Sleep Research, June 2007; 16(2): 148-55). Thus, it is possible to determine the biological rhythm based on the diurnal variations of the heart rate and so on. The diurnal “heartbeats” as used herein encompasses a variety of indices calculated based on the heartbeats, such as the heart rate variability (HRV), the standard deviation of the normal-to-normal intervals (SDNN), and the R-R interval. This also applies to the terms “pulse” and “blood pressure.”

The term “life rhythm information” as used herein refers to time information concerning a daily life cycle (a life rhythm) in real life, such as a sleep onset time, a getting-up time, and mealtimes. Because the biological rhythm is affected by the daily life cycle as noted previously, it is possible to determine an approximate state of the biological rhythm based on the time information concerning the daily life cycle.

The present invention provides an information processing apparatus, an information processing method, and a storage medium which allow users to communicate with each other in a virtual space more smoothly and efficiently by referring to the biological rhythm information about each other.

### BRIEF DESCRIPTION OF THE DRAWINGS

FIG. 1 shows the structure of a virtual space system to which an information processing apparatus according to one embodiment of the present invention is applied;

FIG. 2 illustrates exchange, in the virtual space system, of information concerning avatars;

FIG. 3 shows a specific structure of a terminal;

FIG. 4 shows the structure of a mouse;

FIG. 5 shows the structure of an external device (headphones);

FIG. 6 shows the structure of the external device (a cellular phone); and

FIG. 7 shows a chat screen in a virtual space.

### DETAILED DESCRIPTION OF THE PREFERRED EMBODIMENTS

Hereinafter, preferred embodiments of the present invention will be described with reference to the accompanying drawings. Note that the embodiments that will be described below are merely examples of typical embodiments of the present invention, and should not be interpreted to restrict the scope of the present invention.

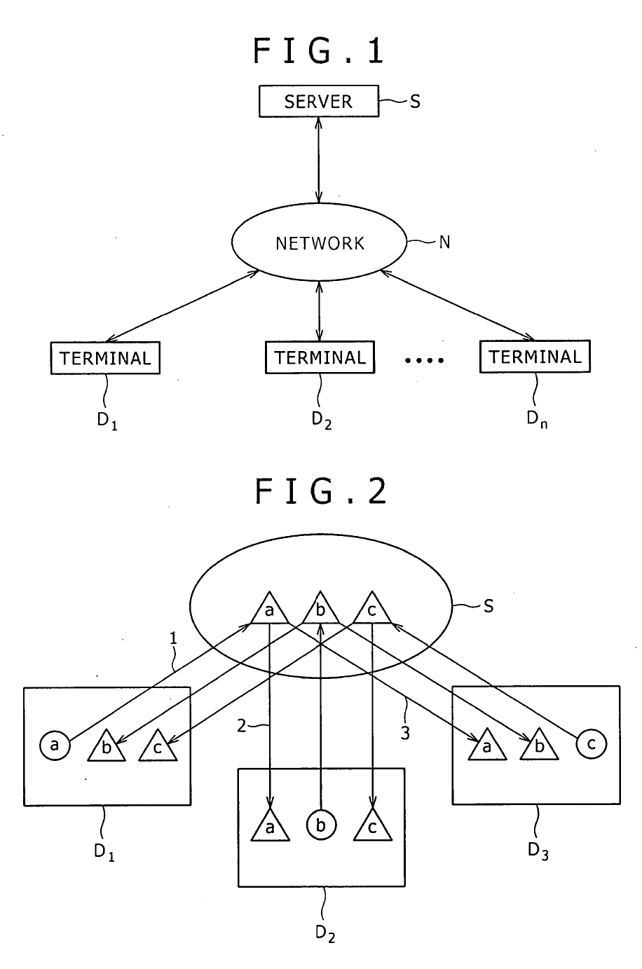

FIG. 1 shows the structure of a virtual space system to which an information processing apparatus according to one embodiment of the present invention is applied.

In FIG. 1, terminals D₁ to Dₙ (hereinafter referred to simply as “terminal D” as appropriate) are connected to a network N, such as the Internet or a similar network, so that the terminals D₁ to Dₙ are capable of exchanging information with a server S.

The server S holds and manages a virtual space, and also functions as management means for holding and managing information concerning objects (avatars), corresponding to users, in the virtual space. The information concerning the avatars includes biological rhythm information about the users, which is attributes of the avatars.

The terminal D is a terminal to be used by a user who connects to the virtual space system. An arbitrary number (n) of terminals D are connected to the system depending on the number of users. The terminal D includes display control means for displaying, on a display section (i.e., a display), information concerning the virtual space and the avatars as held and managed by the server S.

The virtual space system having the above structure allows the user, represented by his or her surrogate (avatar) held and managed by the server S, to move in the virtual space also held and managed by the server S, by using the terminal D. In addition, the users are able to refer to the biological rhythm information about one another via their avatars.

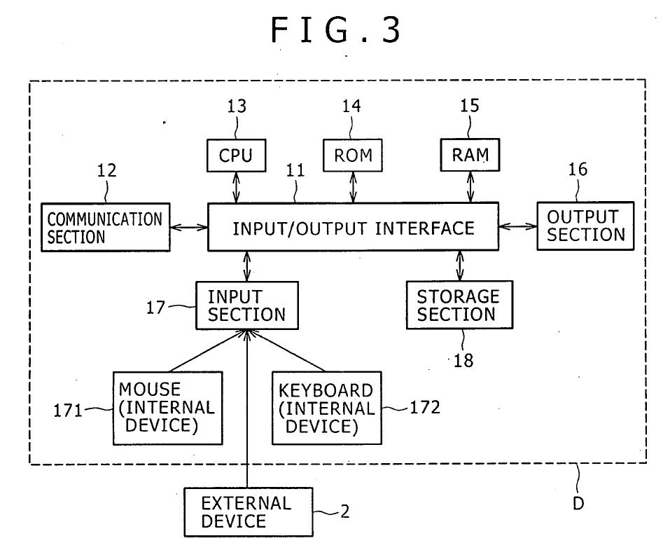

FIG. 2 illustrates exchange, in the virtual space system, of the information concerning the avatars. It is assumed here that three users A, B, and C connect to the system.

In FIG. 2, the terminals D₁, D₂, and D₃ are terminals used by users A, B, and C, respectively. Each of the terminals D₁ to D₃ has a display as an output section. On each display, the corresponding display control means displays the virtual space and information concerning avatar a of user A, avatar b of user B, and avatar c of user C. Avatars a, b, and c exist in the virtual space.

User A is able to operate his or her own surrogate, avatar a, but unable to operate avatars b and c of the other users. Similarly, user B is able to operate only avatar b, and user C is able to operate only avatar c.

In order to manage the avatar of each user, the server S holds the information concerning avatar a of user A, avatar b of user B, and avatar c of user C. This information includes the biological rhythm information about each user as the attributes of the avatars. In addition, the information concerning the avatars includes locations, appearances, and motions thereof. In the server S, the information concerning avatars a, b, and c is held and managed as information shared in the system.

When user A moves his or her own avatar, avatar a, in the virtual space, for example, information concerning this operation is first transmitted from the terminal D₁ to the server S (see arrow 1 in FIG. 2). Based on this information, the server S updates information about the location of avatar a in the virtual space, and transmits the updated information to the terminals D₂ and D₃ (see arrows 2 and 3 in FIG. 2). Then, based on this location information transmitted from the server S, the terminals D₂ and D₃ update their display so as to reflect the movement of avatar a in the virtual space.

Similarly, for example, the biological rhythm information about user A is first transmitted from the terminal D₁ to the server S (see arrow 1 in FIG. 2). Based on this information, the server S updates the biological rhythm information about avatar a, and transmits the updated information to the terminals D₂ and D₃ (see arrows 2 and 3 in FIG. 2). Then, based on the biological rhythm information transmitted from the server S, each of the terminals D₂ and D₃ displays the biological rhythm information about avatar a. It is desirable that the display of this biological rhythm information be performed upon entry of user A into the virtual space and continue until exit of user A from the virtual space.

FIG. 3 shows a specific structure of the terminal D.

In the terminal D, a communication section 12, a central processing unit (CPU) 13, a read only memory (ROM) 14, a random access memory (RAM) 15, an output section 16, an input section 17, and a storage section 18 are connected to an input/output interface 11. This basic structure of the terminal D is shared by the server S.

The communication section 12 exchanges the information with the server S via the network N.

The CPU 13 performs various processes in accordance with a program stored in the ROM 14. In the RAM 15, data, a program, and so on required for the CPU 13 to perform the various processes are stored as appropriate.

Examples of the processes performed by the CPU 13 include a process of displaying, on the display as the output section 16, the information concerning the virtual space and the avatars transmitted from the server S via the communication section 12. That is, the CPU 13 functions as display control means for controlling the display of the information concerning the virtual space and the avatars. In addition, as will be described later, the CPU 13 also functions as determination means for automatically determining a biological rhythm of the user.

Signal are inputted to the input section 17 from internal devices, such as a mouse 171 and a keyboard 172, and an external device 2. Such signals include biological information and life rhythm information about the user.

The biological information and the life rhythm information about the user inputted via the input section 17 are stored in the storage section 18, which is formed by a hard disk or the like. The CPU 13 refers to the biological information and the life rhythm information stored in the storage section 18 to automatically determine the biological rhythm of the user, and transmits a result of the automatic determination, as the life rhythm information, to the server S via the communication section 12 and the network N.

That is, the CPU 13 and the storage section 18 function as determination means for acquiring and storing the biological information or the life rhythm information about the user transmitted from the internal device, such as the mouse 171 or the keyboard 172, or the external device 2, automatically determining the biological rhythm of the user based on the stored information, and transmitting the result of the automatic determination to the server S (the management means).

The storage section 18 also functions as storage means for storing image information for the avatar. From among the image information for the avatar stored in the storage section 18, an appropriate piece of image information is selected by the CPU 13 in accordance with the result of the determination of the biological rhythm transmitted from the server S, and the appropriate piece of image information is displayed on the display, which constitutes the output section 16 (this process will be described in detail later).

The terminal D is constructed as a general-purpose electronic device, such as a personal computer or a cellular phone, that can be connected to the network.

Next, the biological information or the life rhythm information about the user, which is transmitted from the internal device (e.g., the mouse 171, the keyboard 172, etc.) or the external device 2, will now be described in detail below.

First, the biological information and a method of determining the biological rhythm based on the biological information will now be described below.

Examples of the biological information include heartbeats, a pulse, and blood pressure. The internal device, such as the mouse 171 or the keyboard 172, is equipped with a living body contact section (an internal measurement section) formed by a sensor capable of detecting such biological information.

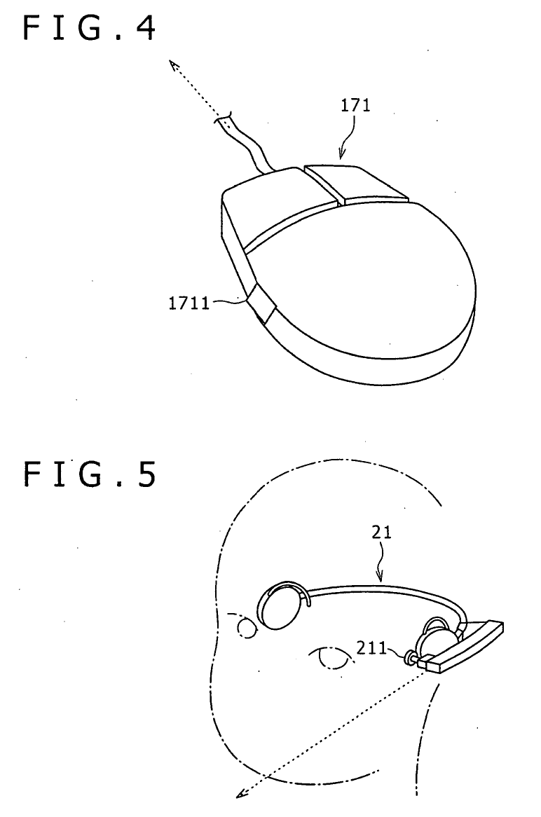

FIG. 4 shows the structure of the mouse 171, which is equipped with a living body contact section 1711.

The mouse 171 has the living body contact section 1711 provided thereon at such a location that a thumb of the user will be in contact with the living body contact section 1711 when the user holds the mouse 171. While the user is holding and operating the mouse 171, the living body contact section 1711 automatically detects the biological information, and transmits the detected biological information to the input section 17 (see a dotted-line arrow in FIG. 4, as well as FIG. 3). The biological information transmitted to the input section 17 is supplied to the storage section 18 via the input/output interface 11, and stored in the storage section 18.

The detection of the biological information by the mouse 171 may be performed not only while the user is present in the virtual space using the terminal D but also while the user is manipulating the mouse 171 to perform various operations with the terminal D. Thus, it is possible to detect the biological information about the user for a greater length of time and store the detected biological information in the storage section 18.

The internal devices are not limited to the above-described mouse 171, but may be other electronic devices, such as the keyboard 172, that form part of the terminal D (i.e., the personal computer, the cellular phone, or the like) and which are in contact with a body surface of the user when used. When such electronic devices are equipped with the living body contact section, the living body contact section can be used to detect the biological information while the user is operating the terminal D. Thus, it is possible to detect the biological information automatically and continuously without the need for the user to be conscious thereof.

FIG. 5 shows the structure of headphones 21, which are a specific example of the external device 2 equipped with the living body contact section.

In FIG. 5, the headphones 21 have a living body contact section 211 provided thereon at such a location that the living body contact section 211 will be in contact with a temple of the user while he or she wears the headphones 21. Temples are known as body parts that allow the detection of the biological information, such as the heartbeats, with great sensitivity.

While the user wears the headphones 21, the living body contact section 211 automatically and continuously detects the biological information and transmits the detected biological information to the input section 17 (see a dotted-line arrow in FIG. 5, as well as FIG. 3).

The biological information detected by the living body contact section 211 may be held and stored within the headphones 21 temporarily. This makes it possible to obtain the biological information about the user even while the user is not connected with the virtual space system. For example, it is possible to detect the biological information about the user while he or she is listening to music using the headphones 21 in a commuter train, and hold and store the detected biological information within the headphones 21. Then, when the user connects to the virtual space system, the biological information held and stored within the headphones 21 is transmitted to the input section 17 collectively. Thus, the biological information detected for an increased length of time can be stored in the storage section 18.

The external device 2 is not limited to the headphones, but may be other electronic devices that are regularly put on a body of the user (i.e., in contact with the body surface) when used. Examples of such electronic devices include a wrist watch. Many techniques have already been developed for wrist watches that are capable of measuring the heartbeats or the like (see Japanese Patent Laid-Open No. Hei 6-289168, Japanese Patent Laid-Open No. Hei 9-285453, and Japanese Patent Laid-Open No. 2005-342163, for example). These techniques can be applied to construct a wrist watch as the external device 2.

Note that the term “external device 2” should not be interpreted to encompass only electronic devices in a narrow sense. For example, the external device 2 may be glasses equipped with a living body contact section similar to that of the headphones, or a ring equipped with a living body contact section similar to that of the wrist watch. In these cases also, it is possible to automatically and continuously detect the biological information and store the detected biological information. Also note that the term “external device 2” should not be interpreted to encompass only small devices. For example, a chair equipped with a heartbeat sensor disclosed in Japanese Patent Laid-Open No. 2007-209446 or the like is applicable as the external device 2.

When the external device 2 is constructed as such a device that is regularly put on the body of the user (i.e., in contact with the body surface) when used, it is possible to automatically and continuously detect the biological information and hold and store the detected biological information, without the need for the user to be conscious thereof, while the user is using the external device 2 for its intended purpose.

Next, the automatic determination of the biological rhythm based on the biological information will now be described below.

The determination of the biological rhythm is made by the determination means formed by the combination of the CPU 13 and the storage section 18. The CPU 13 refers to the biological information stored in the storage section 18 to automatically determine the biological rhythm. One specific method for determining the biological rhythm based on the biological information is described in detail in Japanese Patent Laid-Open No. Hei 4-239380, for example.

Here, as a simpler determination method, a method of determining the biological rhythm based on what time in the daytime a peak heart rate (i.e., the maximum heart rate) appears will be described.

Table 1 shows times when the peak heart rate of the three users A, B, and C appeared in each of ten consecutive days. In the table, “16” means “16:00”, “14.5” means “14:30,” and so on.

TABLE 1

| | | 2nd | 3rd | 4th | 5th | 6th | 7th | 8th | 9th | 10th | |
|---|---|---|---|---|---|---|---|---|---|---|---|
| | 1st day | day | day | day | day | day | day | day | day | day | average |
| A | 16 | 17 | 16.5 | 15.5 | 16.5 | 17 | 16.5 | 17 | 16.5 | 16 | 16.45 |
| B | 14 | 14.5 | 15 | 14 | 14.5 | 14 | 15 | 14.5 | 14 | 14.5 | 14.4 |
| C | 18 | 17.5 | 18 | 17 | 18.5 | 18 | 17.5 | 17 | 18 | 17.5 | 17.7 |

The table shows that, for each of users A to C, the time at which the peak heart rate appeared is significantly steady in the ten days, and that the heartbeats exhibit the circadian rhythm. This means that the time at which the peak heart rate appears can be used as an index to the biological rhythm of the user.

Thus, by storing heart rates as the biological information in the storage section 18 and allowing the CPU 13 to automatically determine the time at which the peak heart rate appears in the daytime, it is possible to obtain the biological rhythm information indicating the state of the biological rhythm of the user on the day. Further, by automatically comparing the determined time at which the peak heart rate appeared with a current time, it is possible to obtain information about whether the biological rhythm of the user is now in an active period (in which the heart rate is high) or in an inactive period (in which the heart rate is low).

Moreover, besides the times at which the peak heart rate appeared, the average or a standard deviation of the times at which the peak heart rate appeared in the past ten days may be automatically determined, for example. In such a manner as well, it is possible to obtain the biological rhythm information indicating the state or stability (or irregularity) of the biological rhythm of the user in the past ten days.

Next, in connection with the biological information or the life rhythm information about the user transmitted from the internal device (e.g., the mouse 171, the keyboard 172, etc.) or the external device 2, the life rhythm information and the method of determining the biological rhythm based on the life rhythm information will now be described in detail below.

The life rhythm information is time information concerning a daily life cycle (a life rhythm), such as a sleep onset time, a getting-up time, and a mealtime. An electronic device capable of storing such time information is applied as the external device 2.

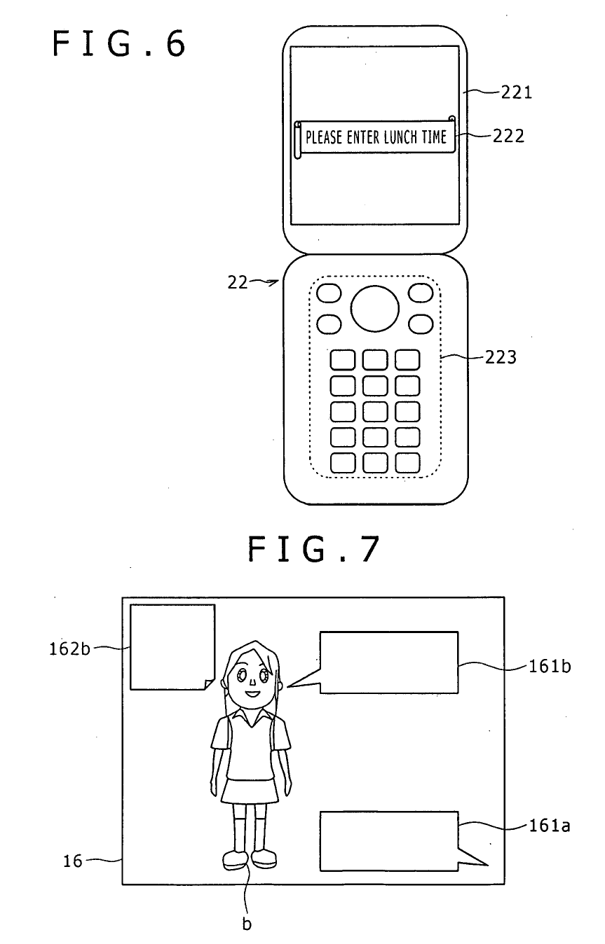

FIG. 6 shows a cellular phone 22 as a specific example of the external device 2 that is configured to be capable of storing the life rhythm information. Today, cellular phones are devices that many people customarily have close at hand, and they are optimum devices to be used for recording and storing the time information concerning the daily life cycle, such as the sleep onset time, the getting-up time, and the mealtime.

Referring to FIG. 6, in a predetermined time period, the cellular phone 22 displays a message (hereinafter referred to as an “entry assistant message”) 222 for prompting the user to enter the time information concerning the daily life cycle on a display 221. In FIG. 6, the entry assistant message 222 reads: “Please enter lunch time.”

Other examples of the entry assistant message 222 include messages that prompt the user to enter the following types of time information concerning the daily life cycle: the sleep onset time, the getting-up time, a breakfast time, and a supper time.

The entry assistant message 222 is displayed in the predetermined time period. For example, the above message “Please enter lunch time” is displayed in a time period around noon. Since a time period for lunch differs from user to user, a suitable time period for the lunch is set for each user, a standard time period ranging from roughly 11 to 14.

When the entry assistant message 222 is used to prompt the user to enter the time information such as his or her sleep onset time, getting-up time, breakfast time, or supper time, the entry assistant message 222 is displayed in an appropriate time period corresponding to the type of the time information. Such time periods may differ from user to user. For example, the time period for sleep onset may range from 23 to 2, the time period for rising or breakfast may range from 6 to 9, and the time period for supper may range from 18 to 21.

After viewing the entry assistant message 222, the user enters time information about a lunch time before, during, or after the lunch, for example.

The time information may be entered by the user manually, by operating input keys 223 to enter numerical values representing the time (e.g., lunch time 12:00). More preferably, the time information is entered in the following manner.

That is, the user, who has viewed the entry assistant message 222, performs some input operation using the input keys 223 (e.g., pressing one of the input keys 223 once, etc.). Then, a corresponding signal is outputted from the input keys 223 so that the current time (e.g., 12:00) held within the cellular phone 22 is automatically recorded as the time information about the lunch time.

In this manner, the time information is recorded and stored in the cellular phone 22 with a simpler operation than entering the numerical values representing the time information. Thus, the user will not forget to enter the time information, and the storage of the life rhythm information will be achieved without fail.

The life rhythm information stored in the cellular phone 22 in such a manner is transmitted, in a wired or wireless manner, to the input section 17 of the terminal D, and supplied to the storage section 18 via the input/output interface 11 to be stored in the storage section 18 (see FIG. 3). Alternatively, the cellular phone 22 may be connected directly to the network N so that the life rhythm information stored in the cellular phone 22 may be supplied to the storage section 18 via the communication section 12 of the terminal D and stored in the storage section 18.

In this case also, the external device 2 is not limited to the above-described cellular phone 22, but may be other devices that the users customarily have close at hand and which are configured to be capable of storing the life rhythm information, as is the case with the cellular phone 22. Examples of such devices include portable information terminals, such as a personal digital assistant (PDA), and the wrist watch.

Next, the automatic determination of the biological rhythm based on the stored life rhythm information will now be described below.

The determination of the biological rhythm is made by the determination means formed by the combination of the CPU 13 and the storage section 18. The CPU 13 refers to the life rhythm information stored in the storage section 18 to automatically determine the biological rhythm.

The life rhythm information is information that reflects the daily life cycle of the user, such as the sleep onset time, the getting-up time, or the mealtime of the user. Because the biological rhythm is affected by the daily life cycle as noted previously, it is possible to determine an approximate state of the biological rhythm based on the life rhythm information.

Here, as a simple determination method, a method of determining the biological rhythm based on the sleep onset time, the getting-up time, and the mealtimes of the user will now be described below. Note that the method of determining the biological rhythm based on the life rhythm information is not limited to the following method, but that there are a variety of other methods available.

Tables 2, 3, and 4 show results of recording the sleep onset time, the getting-up time, and the mealtime in each of ten consecutive days, for the three users A, B, and C, respectively. In each table, the times are expressed in hours. For example, “6:00” is expressed as “6,” and “7:30” is expressed as “7.5” (see the 2nd day in Table 1). Notice how the sleep onset time is expressed when it is after midnight. For example, “1:00 a.m.” is expressed as “25.”

TABLE 2

| | | | | | | | | | | | | Time | Time |
|---|---|---|---|---|---|---|---|---|---|---|---|---|---|
| | | | | | | | | | | | | index | index |
| | Reference | 1st | 2nd | 3rd | 4th | 5th | 6th | 7th | 8th | 9th | 10th | (10 | (standard |
| | times | day | day | day | day | day | day | day | day | day | day | days) | deviation) |
| Sleep | — | 25 | 24 | 25 | 26 | 24.5 | 26 | 25 | 25 | 25 | 25 | 16.3 | 0.96 |
| onset | | | | | | | | | | | | | |
| time | | | | | | | | | | | | | |
| Getting- | — | 7 | 6.5 | 7 | 7.5 | 7 | 7.5 | 6.5 | 7 | 7 | 7 | | |
| up | | | | | | | | | | | | | |
| time | | | | | | | | | | | | | |
| Breakfast | 7 | 8 | 7.5 | 8 | 8 | 8 | 8 | 8 | 8 | 8 | 7.5 | | |
| time | | | | | | | | | | | | | |
| Lunch | 12 | 13 | 12.5 | 13 | 12 | 13.5 | 14 | 13 | 12 | 14 | 12.5 | | |
| time | | | | | | | | | | | | | |
| Supper | 19 | 21 | 20 | 20.5 | 21 | 20.5 | 21 | 21 | 20 | 22 | 20 | | |
| time | | | | | | | | | | | | | |
| Time | | 17.3 | 14.9 | 16.9 | 16.8 | 15.3 | 17.7 | 15.3 | 15.9 | 17.0 | 15.7 | | |
| index | | | | | | | | | | | | | |
| (1 day) | | | | | | | | | | | | | |

TABLE 3

| | | | | | | | | | | | | Time | Time |
|---|---|---|---|---|---|---|---|---|---|---|---|---|---|
| | | | | | | | | | | | | index | index |
| | Reference | 1st | 2nd | 3rd | 4th | 5th | 6th | 7th | 8th | 9th | 10th | (10 | (standard |
| | times | day | day | day | day | day | day | day | day | day | day | days) | deviation) |
| Sleep | — | 26 | 27 | 26.5 | 25.5 | 27 | 26.5 | 27.5 | 26 | 27 | 27.5 | 17.7 | 0.90 |
| onset | | | | | | | | | | | | | |
| time | | | | | | | | | | | | | |
| Getting- | — | 8 | 9 | 8.5 | 9 | 9.5 | 9 | 9.5 | 8.5 | 9 | 9 | | |
| up | | | | | | | | | | | | | |
| time | | | | | | | | | | | | | |
| Breakfast | 7 | 8.5 | 9.5 | 9 | 9.5 | 10 | 9.5 | 10 | 9 | 9.5 | 9.5 | | |
| time | | | | | | | | | | | | | |
| Lunch | 12 | 14 | 13 | 14 | 14.5 | 14 | 14 | 14.5 | 13.5 | 14 | 14 | | |
| time | | | | | | | | | | | | | |
| Supper | 19 | 21 | 21.5 | 22 | 21.5 | 22 | 22.5 | 21.5 | 22 | 21 | 21.5 | | |
| time | | | | | | | | | | | | | |
| Time | | 18.8 | 18.0 | 16.8 | 17.3 | 18.7 | 17.2 | 18.4 | 15.9 | 17.9 | 17.6 | | |
| index | | | | | | | | | | | | | |
| (1 day) | | | | | | | | | | | | | |

TABLE 4

| | | | | | | | | | | | | Time | Time |
|---|---|---|---|---|---|---|---|---|---|---|---|---|---|
| | | | | | | | | | | | | index | index |
| | Reference | 1st | 2nd | 3rd | 4th | 5th | 6th | 7th | 8th | 9th | 10th | (10 | (standard |
| | times | day | day | day | day | day | day | day | day | day | day | days) | deviation) |
| Sleep | — | 23 | 23.5 | 23 | 23 | 23.5 | 23 | 22.5 | 23 | 23.5 | 24 | 15.0 | 0.52 |
| onset | | | | | | | | | | | | | |
| time | | | | | | | | | | | | | |
| Getting- | — | 5 | 5 | 5.5 | 6 | 5.5 | 5 | 5.5 | 5.5 | 6 | 6 | | |
| up | | | | | | | | | | | | | |
| time | | | | | | | | | | | | | |
| Breakfast | 7 | 6 | 5.5 | 6 | 6.5 | 6 | 6 | 6 | 6 | 7 | 6.5 | | |
| time | | | | | | | | | | | | | |
| Lunch | 12 | 13 | 12.5 | 11.5 | 12 | 13.5 | 14 | 13 | 12 | 12.5 | 12.5 | | |
| time | | | | | | | | | | | | | |
| Supper | 19 | 19 | 18.5 | 19 | 19 | 20 | 19.5 | 18.5 | 20 | 19 | 20 | | |
| time | | | | | | | | | | | | | |
| Time | | 14.0 | 14.8 | 14.5 | 15.1 | 15.5 | 15.0 | 14.8 | 15.3 | 15.7 | 15.6 | | |
| index | | | | | | | | | | | | | |
| (1 day) | | | | | | | | | | | | | |

First, with respect to each day, a “time index (1 day)” is calculated by the following equation (1).

$$\begin{matrix}[ Equation 1 ] & \\ Time index ( 1 day ) = \frac{( \begin{matrix}sleep onset time + \\ getting \text{-} up time\end{matrix} )}{2} + \frac{\{ \begin{matrix}( \begin{matrix}breakfast time - \\ reference breakfast time\end{matrix} ) + \\ ( \begin{matrix}lunch time - \\ reference lunch time\end{matrix} ) + ( \begin{matrix}supper time - \\ reference supper time\end{matrix} )\end{matrix} \}}{3} & Eq . ( 1 )\end{matrix}$$

It is assumed here that the reference breakfast time, the reference lunch time, and the reference supper time are 7, 12, and 19, respectively (see “reference times” in the tables). For example, referring to Table 2, the “time index (1 day)” of the first day of user A is (25+7)/2+{(8−7)+(13−12)+(21−19)}/3=17.3.

Next, a “time index (10 days)” and a “time index (standard deviation),” which are the average and standard deviation of the ten days of “time index (1 day),” respectively, are calculated. For example, the “time index (10 days)” and the “time index (standard deviation)” of user A of Table 2 are 16.3 and 0.96, respectively.

Similarly, the “time index (10 days)” and the “time index (standard deviation)” of user B are 17.7 and 0.90, respectively, and the “time index (10 days)” and the “time index (standard deviation)” of user C are 15.0 and 0.52, respectively.

Referring to Table 2, with respect to the first to tenth days, the value of the “time index (1 day)” of user A ranges from 14.9 to 17.7. Referring to Table 3, with respect to the first to tenth days, the value of the “time index (1 day)” of user B ranges from 15.9 to 18.8. Referring to Table 4, with respect to the first to tenth days, the value of the “time index (1 day)” of user C ranges from 14.0 to 15.7. Thus, the range of the value of the “time index (1 day)” of user C is the narrowest of the three. This means that user C has the most regular life rhythm. This is confirmed by the fact that the “time index (standard deviation)” of user A is the highest, followed by that of user B and that of user C in this order.

Thus, if the life rhythm information is stored in the storage section 18, and the CPU 13 calculates the “time index (1 day)” and the “time index (10 days)” by automatic determination using the above equation (1), for example, the biological rhythm information can be obtained that indicates the approximate state of the biological rhythm of each user on the day or during the ten days.

Further, by calculating the “time index (standard deviation)” by automatic determination, it is possible to obtain the biological rhythm information indicating the degree of stability (or irregularity) of the biological rhythm of the user.

The biological rhythm information obtained as described above based on the biological information or the life rhythm information about the user transmitted from the internal device (e.g., the mouse 171, the keyboard 172, etc.) or the external device 2 is transmitted to the server S via the communication section 12 and the network N.

After receiving the biological rhythm information, the server S updates the biological rhythm information corresponding to the avatar of the user based on the received information, and transmits the updated biological rhythm information to the terminal D of each user. Then, each of the terminals D displays the biological rhythm information of the avatar based on the biological rhythm information transmitted from the server S.

Next, a specific method of displaying the biological rhythm information in the virtual space system will now be described below.

The biological rhythm information about the avatar may be displayed when the users have a chat in the virtual space, for example. FIG. 7 shows the output section 16 (i.e., the display) of the terminal D₁ of user A, when user A has a chat with user B in the virtual space.

In FIG. 7, reference character b indicates the avatar of user B. Similarly, avatar a of user A is displayed on the output section 16 of the terminal D₂ of user B. Users A and B have a chat via their respective avatars, avatars a and b.

In FIG. 7, reference character 161b indicates a chat message display section for user B (i.e., avatar b), while reference character 161a indicates a chat message display section for user A (i.e., avatar a). User A chats with user B by entering his or her own message in the chat message display section 161a in response to a message from user B (i.e., avatar b) displayed on the chat message display section 161b.

In FIG. 7, reference character 162b indicates an avatar information display section for displaying information concerning avatar b. In the avatar information display section 162b is displayed the attributes set in avatar b, i.e., information concerning the age, sex, country, interests, etc. of user B as well as the biological rhythm information about user B.

The biological rhythm information displayed in the avatar information display section 162b may be displayed in the form of numerical values representing the time when the peak heart rate appeared, the “time index,” or the like as described above. In place of the numerical values, images that represent those numerical values and which are determined according to a predetermined rule may be displayed. For example, the time when the peak heart rate appeared and the standard deviation of the “time indices” can be used as the biological rhythm information indicating the degree of stability of the biological rhythm of the user. In the case of the “time index (standard deviation)” as described above (see Tables 2 to 4), values below 0.5 may be represented by a circle, values between 0.5 (inclusive) and 0.8 (exclusive) by a triangle, and values of 0.8 or more by a cross. In this manner, the biological rhythm information may be displayed in the form of symbols, figures, patterns, and so on.

Moreover, the display of the biological rhythm information may be accomplished with an image of the avatar. In the case of the above example, avatar b may have a “smile” when the value of the “time index (standard deviation)” is below 0.5, a “normal facial expression” when the value of the “time index (standard deviation)” is between 0.5 inclusive and 0.8 exclusive, and a “facial expression indicative of poor health” when the value of the “time index (standard deviation)” is 0.8 or above. The display of the biological information using the image information of the avatar may be accomplished not only by way of the facial expression of the avatar but also by way of a motion of the avatar represented by a video image.

Such image information of the avatar is stored in the storage section 18, which serves as means for storing pieces of image information for the avatar. In accordance with the result of the determination of the biological rhythm transmitted from the server S, the CPU 13 selects an appropriate piece of image information, and displays it on the output section 16 (i.e., the display). By expressing the biological rhythm information by way of the image of the avatar, it is possible to convey the biological rhythm information about user B to user A in a more intuitive and sensuous manner.

Note that the biological rhythm information of the avatar may be expressed by way of the image of the avatar not only when a chat is being conducted but also when the avatar is traveling in the virtual space.

For example, the image of avatar a that is traveling in the virtual space as displayed on the display of user A may be presented as image information representing the “smile,” the “normal facial expression,” or the “facial expression indicative of poor health” depending on the biological rhythm information about user A as transmitted from the server S. Thus, user A is informed of the state of his or her own biological rhythm. Further, it is possible to show abnormality of the biological rhythm in a more intuitive and sensuous manner, by displaying the avatar image as a video image indicative thereof.

Moreover, when the images of the avatars that are traveling in the virtual space represent the biological rhythm information about the avatars, the users are able to recognize the state of the biological rhythm of the avatars of other users which they pass by while traveling in the virtual space, before attempting to communicate with another user via chat or the like.

As described above, in the present virtual space system, the biological rhythm information about the users are conveyed to the other users in the form of the numerical value information, the symbols, the facial expressions of the avatars, or the like at the time of the communication such as the chat. Thus, the users are able to communicate with each other while referring to the biological rhythm information about each other.

Further, by allowing the image information of the avatars that travel in the virtual space to be varied based on the biological rhythm information about the corresponding users, it is possible to offer, to avatars that pass by each other in the virtual space, an occasion to start a communication therebetween, and it is also possible to allow two users to start a communication therebetween when both of the users are in the most active state.

Thus, the present virtual space system allows users having the same biological rhythm information to gather to establish a community, and also enables a user to gather users having a particular biological rhythm for marketing for electronic commerce, for example. In such a manner, the present virtual space system is capable of making the communication in the virtual space smoother and more efficient.

Further, in order to assist male and female users in an established community with their acquaintance, it is possible to perform a compatibility test based on the biological rhythm information, or determine a success rate of pregnancy of a virtual family formed by avatars in the virtual space based on the biological rhythm information. For example, the result of the compatibility test may be made more favorable for male and female users who have closer numerical values representing the time at which the peak heart rate appeared, the “time index,” or the like, which represents the biological rhythm information. Also, the success rate of pregnancy may be made higher for male and female users who have more stable numerical values.

Still further, for example, it is possible to perform a medical examination based on the biological rhythm information assigned to the avatars in the virtual space, and make an explanation of the effect of the biological rhythm on health or provide an instruction to maintain a stable biological rhythm for users whose life rhythm information indicates an unstable life rhythm. Thus, new forms of use of the virtual space can be provided.

As described above, the recognition of the state of health of the users (actual entities) is possible via their avatars in the virtual space. For example, this may be combined with the electronic commerce to realize an application of selling a light-emitting device (e.g., a portable light-emitting device as disclosed in Japanese Patent Laid-Open No. Hei 11-39916, etc.) that is usable to better the biological rhythm, health supplements, or the like to the users whose life rhythm information indicates an unstable life rhythm.

Still further, when there is a need to conduct a social statistical survey regarding the life rhythm, e.g., sleep times or the mealtimes, subjects may be collected via the avatars in the virtual space. Thus, it may be possible to obtain a larger statistical population more easily than by collecting the subjects in the real world.

Lastly, a storage medium according to one embodiment of the present invention will be roughly described. The above-described series of processes may be implemented either in hardware or software. In the case where the series of processes is implemented in software, a program that constitutes the software is installed from the storage medium into a computer having a dedicated hardware configuration, a general-purpose personal computer that are capable of performing various functions when various programs are installed thereon, or the like, for example.

Examples of such a storage medium include: packaged media which store the program and are delivered to the users to provide the program, such as magnetic disks (including floppy disks), optical discs (including compact disk-read only memories (CD-ROMs) and digital versatile disks (DVDs)), magneto-optical disks (including Mini-Disks (MDs)), and semiconductor memories; and ROMs, hard disks, and so on which store the program and are provided to the users along with computers containing them.

Note that the steps described in the program provided via the storage medium may naturally be performed chronologically in the order described in the present specification, but do not need to be performed chronologically. Some of the steps may be performed in parallel or independently of one another.

Also note that the term “system” as used in this specification refers to an apparatus as a whole composed of a plurality of devices.

An information processing apparatus, an information processing method, and a storage medium according to one embodiment of the present invention allow users to communicate with each other in the virtual space more smoothly and efficiently by referring to the biological rhythm information about each other. Thus, the electronic commerce and advertisement, marketing, and so on for business transactions in the virtual space can be conducted more effectively, for example.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
management means for managing biological rhythm information about a user; and
display control means for displaying the biological rhythm information so as to be associated with an object corresponding to the user.

2. The information processing apparatus according to claim 1, wherein,
the object exists in a virtual space, and
said display control means displays the biological rhythm information and the object so as to be associated with each other while the user is present in the virtual space.

3. The information processing apparatus according to claim 2, further comprising
determination means for acquiring and storing biological information about the user transmitted from an external device and/or an internal measurement section, automatically determining a biological rhythm of the user based on the stored biological information, and transmitting a result of the automatic determination to said management means as the biological rhythm information.

4. The information processing apparatus according to claim 3, wherein the biological information is one or more pieces of information selected from the group consisting of heartbeats, a pulse, and blood pressure.

5. The information processing apparatus according to claim 2, further comprising
determination means for acquiring and storing life rhythm information about the user transmitted from an external device, automatically determining a biological rhythm of the user based on the stored life rhythm information, and transmitting a result of the automatic determination to said management means as the biological rhythm information.

6. The information processing apparatus according to one of claims 3 and 5, further comprising
storage means for storing a plurality of pieces of image information for the object, wherein
said display control means selects and displays one or more of the plurality of pieces of image information stored in said storage means based on the biological rhythm information.

7. An information processing method, comprising the steps of:
managing biological rhythm information about a user; and
displaying the biological rhythm information so as to be associated with an object corresponding to the user.

8. A storage medium having stored a computer-readable program for allowing a computer to perform the steps of:
managing biological rhythm information about a user; and
displaying the biological rhythm information so as to be associated with an object corresponding to the user.

9. An information processing apparatus, comprising:
a management section configured to manage biological rhythm information about a user; and
a display control section configured to display the biological rhythm information so as to be associated with an object corresponding to the user.
